(19) United States
(12) Patent Application Publication
(10) Pub. No.: US 2005/0222982 A1
(43) Pub. Date: Oct. 6, 2005

(54) System and method for responding to search requests in a computer network

(76) Inventors: Remigiusz K. Paczkowski, Belmont, CA (US); Dominic Bennett, Los Altos, CA (US); Scott Vandevelde, Menlo Park, CA (US); Jason F. Fairchild, Rolling Hills Estates, CA (US); Benjamin M. Lindsey, Cupertino, CA (US)

Correspondence Address: OKAMOTO & BENEDICTO, LLP, P.O. BOX 641330, SAN JOSE, CA, 95164, US

(21) Appl. No.: 10/815,112

(22) Filed: Mar. 31, 2004

(51) Int. Cl. G06F 17/30

(52) U.S. Cl. 707/3

(57) ABSTRACT

In one embodiment, a message server computer receives client data from a plurality of client computers. The client data may include consumer search, navigation, and/or behavioral information indicative of consumer preferred links for particular keywords. For example, the client data may include recordings of consumer actions across several, different search engines. Upon receipt of a search request for a keyword, a search engine may pass the keyword to the message server computer. The message server computer may generate a set of links determined to be relevant to the keyword based on client data received from the client computers. The search engine may include the set of links in a search result, and provide the search result to the consumer who made the search request. The search result advantageously includes links that are known to be preferred by other consumers performing searches on the Internet.

### BACKGROUND OF THE INVENTION

1. Field of the Invention

The present invention relates generally to computer systems, and more particularly but not exclusively to techniques for responding to search requests in a computer network.

2. Description of the Background Art

The Internet is an example of a computer network. On the Internet, consumers on client computers may access various types of information resident in server computers. A server computer that provides information over the Internet is also referred to as a “web server” or a “website”. A website may provide information about various topics, or offer goods and services. A website may comprise a plurality of downloadable documents, such as web pages and files. A consumer may use a web browser to receive and view a web page.

Because of the large number of websites on the Internet, searching the Internet for specific information usually requires the services of a search engine. Generally speaking, a search engine helps consumers look for relevant web pages. A typical search engine accepts a word or a phrase, referred to herein as a “keyword.” The search engine employs the keyword in conjunction with its search algorithm to find matching web pages. The matching web pages are presented to the consumer in the form of a listing referred to as a “search result.” Typical search results list the matching web pages as clickable links, with each link pointing to a corresponding web page. Examples of websites with search engines include Yahoo, Google, and Alta Vista.

### SUMMARY

In one embodiment, a message server computer receives client data from a plurality of client computers. The client data may include consumer search, navigation, and/or behavioral information indicative of consumer preferred links for particular keywords. For example, the client data may include recordings of consumer actions across several, different search engines. Upon receipt of a search request for a keyword, a search engine may pass the keyword to the message server computer. The message server computer may generate a set of links determined to be relevant to the keyword based on client data received from the client computers. The search engine may include the set of links in a search result, and provide the search result to the consumer who made the search request. The search result advantageously includes links that are known to be preferred by other consumers performing searches on the Internet.

These and other features of the present invention will be readily apparent to persons of ordinary skill in the art upon reading the entirety of this disclosure, which includes the accompanying drawings and claims.

### DESCRIPTION OF THE DRAWINGS

FIG. 1 shows a schematic diagram of an example computer that may be used in embodiments of the present invention.

FIG. 2 shows a schematic diagram of a computing environment in accordance with an embodiment of the present invention.

FIG. 3 shows an example web page from a search engine.

FIG. 4 shows an example search result displayed in an instance of a web browser.

FIG. 5 pictorially illustrates a sequence of events that may occur when the consumer clicks on a link listed in a search result, in accordance with an embodiment of the present invention.

FIG. 6 schematically shows a data packet in accordance with an embodiment of the present invention.

FIG. 7 schematically shows a message unit in accordance with an embodiment of the present invention.

FIG. 8 pictorially illustrates the creation of a search model in accordance with an embodiment of the present invention.

FIG. 9 pictorially illustrates a process for ranking links for particular keywords, in accordance with an embodiment of the present invention.

FIG. 10 pictorially illustrates a process for optimizing a layout for presenting a search result, in accordance with an embodiment of the present invention.

FIGS. 11A, 11B, and 11C show layouts for presenting search results in accordance with embodiments of the present invention.

FIG. 12 shows a flow diagram of a method of responding to a search request in accordance with an embodiment of the present invention.

The use of the same reference label in different drawings indicates the same or like components.

### DETAILED DESCRIPTION

In the present disclosure, numerous specific details are provided, such as examples of apparatus, components, and methods, to provide a thorough understanding of embodiments of the invention. Persons of ordinary skill in the art will recognize, however, that the invention can be practiced without one or more of the specific details. In other instances, well-known details are not shown or described to avoid obscuring aspects of the invention.

Being computer-related, it can be appreciated that the components disclosed herein may be implemented in hardware, software, or a combination of hardware and software (e.g., firmware). Software components may be in the form of computer-readable program code stored in a computer-readable storage medium such as memory, mass storage device, or removable storage device. For example, a computer-readable medium may comprise computer-readable program code for performing the function of a particular component. Likewise, computer memory may be configured to include one or more components, which may then be executed by a processor. Components may be implemented separately in multiple modules or together in a single module.

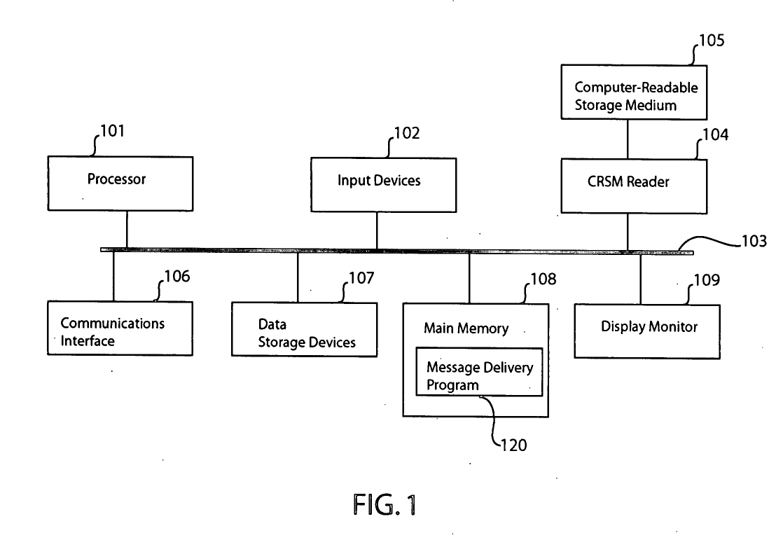

Referring now to FIG. 1, there is shown a schematic diagram of an example computer that may be used in embodiments of the present invention. Depending on its configuration, the computer shown in the example of FIG. 1 may be employed as a client computer, a server computer, or other data processing device. The computer of FIG. 1 may have less or more components to meet the needs of a particular application. As shown in FIG. 1, the computer may include a processor 101, such as those from the Intel Corporation or Advanced Micro Devices, for example. The computer may have one or more buses 103 coupling its various components. The computer may include one ore more input devices 102 (e.g., keyboard, mouse), a computer-readable storage medium (CRSM) 105 (e.g., floppy disk, CD-ROM), a CRSM reader 104 (e.g., floppy drive, CD-ROM drive), a display monitor 109 (e.g., cathode ray tube, flat panel display), a communications interface 106 (e.g., network adapter, modem) for coupling to a network, one or more data storage devices 107 (e.g., hard disk drive, optical drive, FLASH memory), and a main memory 108 (e.g., RAM). Software embodiments may be stored in a computer-readable storage medium 105 for reading into a data storage device 107 or main memory 108. Software embodiments in main memory 108 may be executed by processor 101. In the example of FIG. 1, main memory 108 is shown as having a message delivery program 120, which is further described below. Message delivery program 120 and other programs in main memory 108 may be loaded from a computer-readable storage medium 105, a data storage device 107, or over the Internet by way of communications interface 106, for example. Message delivery program 120 and other programs in main memory 108 may be executed by processor 101.

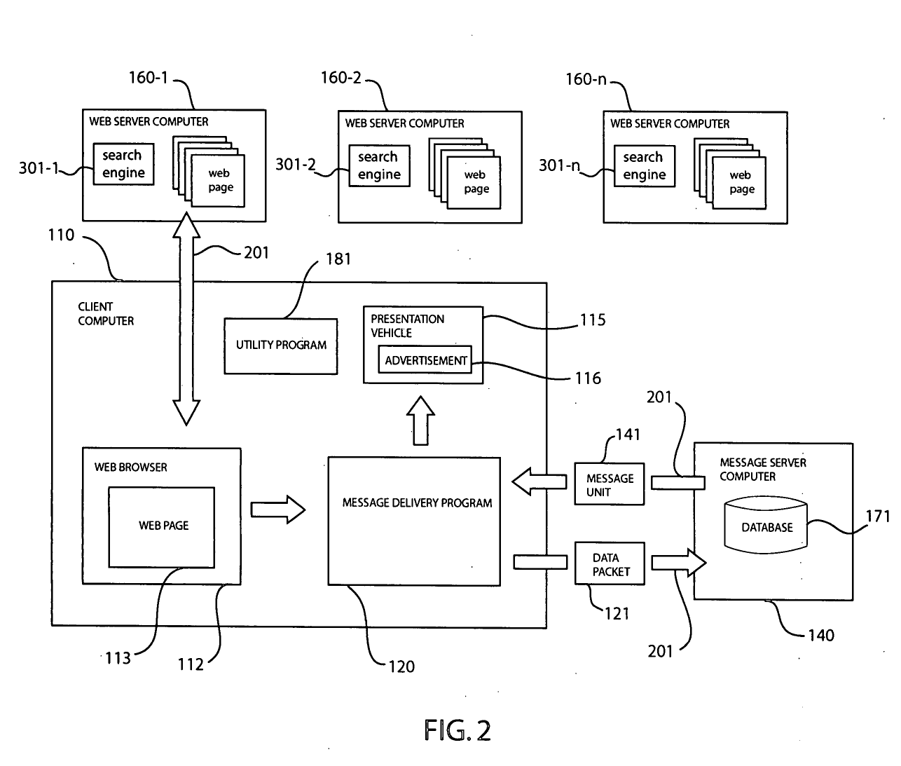

FIG. 2 shows a schematic diagram of a computing environment in accordance with an embodiment of the present invention. In the example of FIG. 2, the computing environment includes one or more web server computers 160 (i.e., 160-1, 160-2, . . . ), one or more client computers 110, one or more message server computers 140, and other computers not specifically shown. In the example of FIG. 2, a client computer 110 communicates with server computers (e.g., a web server computer or a message server computer) over the Internet. As such, arrows 201 denote Internet connections. Intermediate nodes such as gateways, routers, bridges, Internet service provider networks, public-switched telephone networks, proxy servers, firewalls, and other network components are not shown for clarity.

A client computer 110 is typically, but not necessarily, a personal computer such as those running the Microsoft Windows™ operating system, for example. A consumer may employ a suitably equipped client computer 110 to get on the Internet and access computers coupled thereto. For example, a client computer 110 may be used to access web pages from a web server computer 160.

A web server computer 160 may be a server computer hosting a website, which comprises web pages designed to attract consumers surfing on the Internet. A web server computer 160 may include advertisements, downloadable computer programs, a search engine, and products available for online purchase. In the example of FIG. 2, web server computers 160 are shown as including search engines 301 (i.e., 301-1, 301-2, . . . ). For purposes of the present disclosure, a web server computer hosting a website or including a search engine is also simply referred to as a “website” or a “search engine,” respectively. As can be appreciated, a website or a search engine may be on one or more server computers.

A message server computer 140 may include the functionalities of a web server computer 160. In one embodiment, a message server computer 140 further includes a database 171. Database 171 may be a commercially available database, such as those available from the Oracle Corporation. As will be more apparent below, database 171 may store client data received from message delivery programs 120 running in client computers 110. The client data may be transmitted from a client computer 110 to message server computer 140 in a data packet 121. The client data may include navigation, behavioral, and search data obtained by a message delivery program 120 by monitoring a consumer's online activities. In the example of FIG. 2, message server computer 140 is shown as communicating with one client computer 110 for clarity of illustration. In practice, message server computer 140 receives data packets 121 containing client data from a plurality of client computers 110 that have message delivery programs 120. A message server computer 140 may also include downloadable computer programs and files for supporting, updating, and maintaining software components on a client computer 110.

Web server computers 160 and message server computers 140 are typically, but not necessarily, server computers such as those available from Sun Microsystems, Hewlett-Packard, or International Business Machines. A client computer 110 may communicate with a web server computer 160 or a message server computer 140 using client-server protocol. It is to be noted that client-server computing is well known in the art and will not be further described here.

As shown in FIG. 2, a client computer 110 may include a web browser 112 and a message delivery program 120. Web browser 112 may be a commercially available web browser or web client. In one embodiment, web browser 112 comprises the Microsoft Internet Explorer™ web browser. A web browser allows a consumer on a client computer to access a web page. In the example of FIG. 2, web browser 112 is depicted as displaying a web page 113 from a web server computer 160. A web page, such as web page 113, has a corresponding address referred to as a “URL” (Uniform Resource Locator). Web browser 112 is pointed to the URL of a web page to receive that web page in client computer 110. Web browser 112 may be pointed to a URL by entering the URL at an address window of web browser 112, or by clicking a link pointed to that URL, for example. A web page may include an area where a keyword may be entered for search purposes. For example, web page 113 may be from web server computer 160-1, which includes a search engine 301-1. A consumer desiring to find information on robots may enter the keyword “robots” in a field in web page 113 to tell search engine 301-1 to search for robot-related information on the Internet. In response, search engine 301-1 may return a web page containing links to robot-related web pages on the Internet. It is to be noted that a keyword may comprise a single word or a phrase.

In one embodiment, message delivery program 120 is downloadable from a message server computer 140 or a web server computer 160. Message delivery program 120 may be downloaded to a client computer 110 in conjunction with the downloading of another computer program. For example, message delivery program 120 may be downloaded to client computer 110 along with a utility program 181 that is provided free of charge or at a reduced cost. Utility program 181 may be an e-wallet or calendar program, for example. Utility program 181 may be provided to a consumer in exchange for the right to deliver advertisements to that consumer's client computer 110 via message delivery program 120. In essence, revenue from advertisements delivered to the consumer helps defray the cost of creating and maintaining the utility program. Message delivery program 120 may also be provided to the consumer along with free or reduced cost access to an online service, for example.

Message delivery program 120 is a client program in that it is stored and run in a client computer 110. Message delivery program 120 may comprise computer-readable program code for displaying advertisements in a client computer 110 and for monitoring the online activity of a consumer on the client computer 110. It is to be noted that the mechanics of monitoring a consumer's online activity, such as determining where a consumer is navigating to, the URL of web pages received in client computer 110, the domain names of websites visited by the consumer, what the consumer is typing on a web page, what keyword the consumer is providing to a search engine, whether the consumer clicked on a link or an advertisement, when the consumer activates a mouse or keyboard, and the like, is, in general, known in the art and not further described here. For example, message delivery program 120 may learn of consumer online activities by receiving event notifications from web browser 112.

Message delivery program 120 may record the consumer's online activity for reporting to message server computer 140. The recorded consumer online activity is also referred to as “client data,” and provided to message server computer 140 using data packets 121. Message server computer 140 may use the client data to provide targeted advertisements to the consumer. Message server computer 140 may include the advertisement or data for displaying the advertisement in a message unit 141. In the example of FIG. 2, the targeted advertisement is labeled as advertisement 116 and displayed in a presentation vehicle 115. Presentation vehicle 115 may be a pop-under, pop-up, separate browser window, custom browser window, or other means for displaying an advertisement on a computer screen. Techniques for delivering advertisements to client computers using a client program are also disclosed in commonly-owned U.S. application Ser. No. 10/152,204, entitled “Method and Apparatus for Displaying Messages in Computer Systems,” filed on May 21, 2002 by Scott G. Eagle, David L. Goulden, Anthony G. Martin, and Eugene A. Veteska, which is incorporated herein by reference in its entirety.

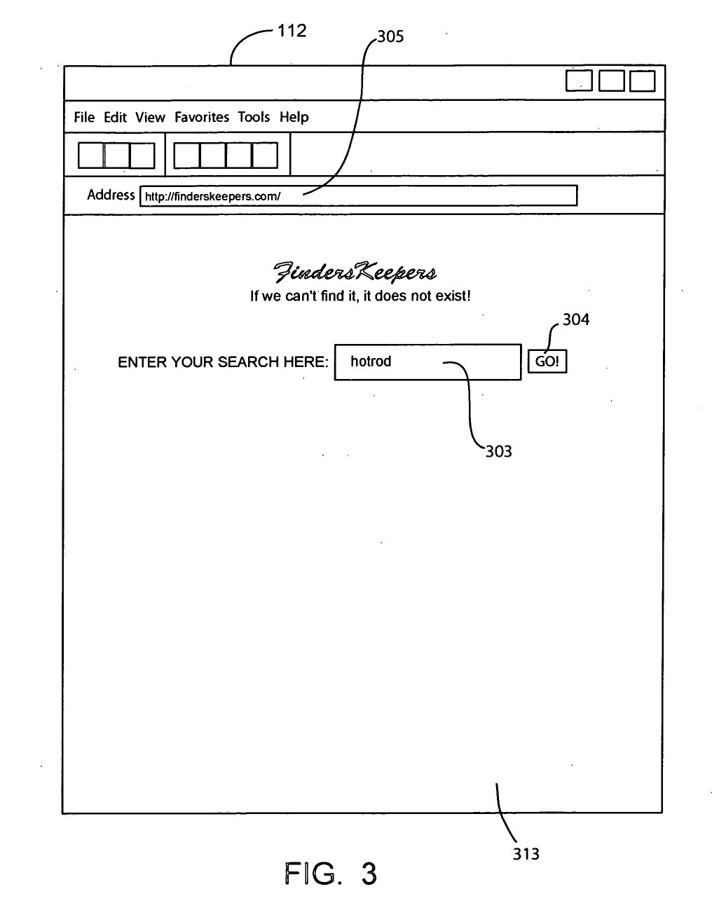

FIG. 3 shows an example web page 313 from a search engine. Web page 313 may be displayed in an instance of web browser 112. Web browser 112 may include an address field 305 indicating the location of web page 313 on the Internet. Web page 313 may include a field 303 where a consumer may enter a keyword to be searched. In the example of FIG. 3, the consumer entered the keyword “hotrod” in field 303. Activating (e.g., clicking using a mouse or another pointing device) button 304 tells the search engine to search for web pages relating to “hotrod” on the Internet. In one embodiment, message delivery program 120 records the address (e.g., the URL indicated on address field 305) of web page 313 to keep track of the search engine employed by the consumer, and the keyword entered in field 303. Message delivery program 120 includes the keyword and the address of the search engine as search data in a data packet 121 provided to message server computer 140.

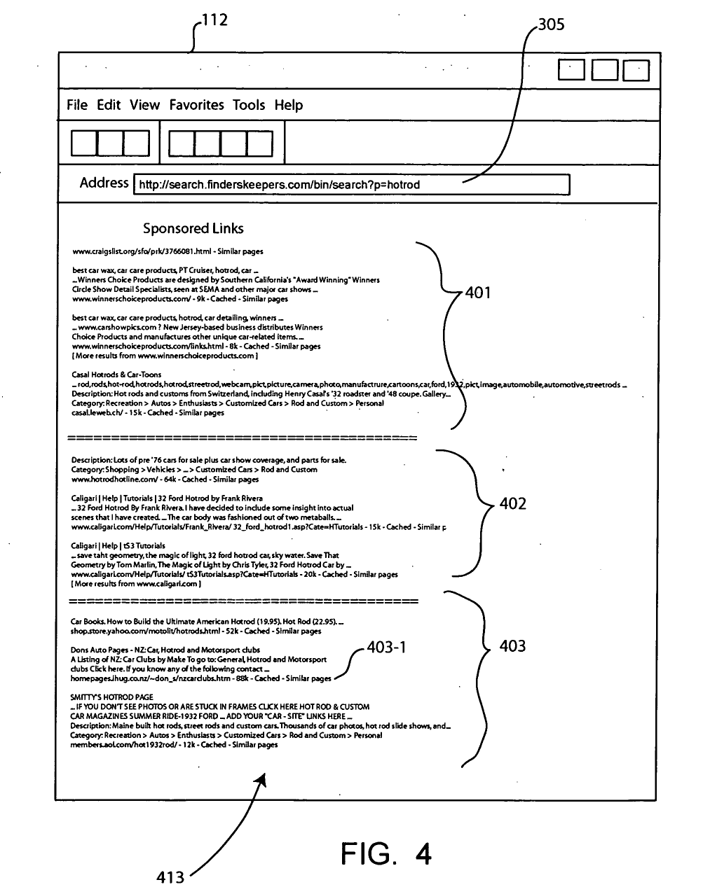

FIG. 4 shows an example search result 413 displayed in an instance of web browser 112. Search result 413 may be in the form of a web page comprising links to web pages related to the keyword entered by the consumer in field 303. Generally speaking, a link points to a document on the Internet; the link may be activated to receive the document in the client computer. A search result may include different types of links. Each type of link may be separated in the search result to provide notice to the consumer. In one embodiment, message delivery program 120 records the addresses of the links (e.g., the URLs) and the types of the links in a search result responsive to the keyword. The keyword, the links responsive to the keyword, and the types of the links may be included as search data in a data packet 121 provided to message server computer 140. A keyword and a link responsive to the keyword are also referred to as a keyword-link combination.

In the example of FIG. 4, search result 413 includes three types of links: sponsored links 401, paid inclusion links 402, and algorithmic links 403. The number and type of links included in a search result depend on the particular search engine. A sponsored link 401 may comprise a link to a web page of a website that pays a fee to be listed in the search result regardless of the keyword entered by the consumer. That is, a sponsored link 401 may or may not be relevant to the keyword. Paid inclusion links 402 may comprise a link to a web page of a website that pays a fee to be ranked higher than non-paying or lower paying websites in a search using a particular keyword. For example, a website may pay a fee to be included in searches using the keyword “apple.” When a consumer searches using that keyword, a link to a web page of that website will be placed higher than those of non-paying websites or those that paid less for that keyword. Paid inclusion links are also known as pay for performance links. An algorithmic link 403 may comprise a link to a web page determined to be relevant using the search engine's search algorithm. Because they are selected based on content rather than fees paid, algorithmic links 403 are typically more relevant to the keyword compared to sponsored or paid inclusion links.

Techniques for providing search results are also disclosed in commonly-assigned U.S. application Ser. No. 10/289,123, entitled “Responding to End-user Request for Information in a Computer Network,” filed by Eugene A. Veteska, David L. Goulden, and Anthony G. Martin on Nov. 5, 2002, which is incorporated herein by reference in its entirety.

The consumer may activate a link on the search result to receive the corresponding document. For example, the consumer may click on link 403-1 of search result 413 to navigate to the web page pointed to by the link. In one embodiment, message delivery program 120 records the consumer activated links as behavioral data in a data packet 121 provided to message server computer 140. The activated links are indicative of the relevance of the link to the keyword entered by the consumer. Message server computer 171 may thus use the contents of data packets 121 to determine the popular, consumer preferred links for particular keywords.

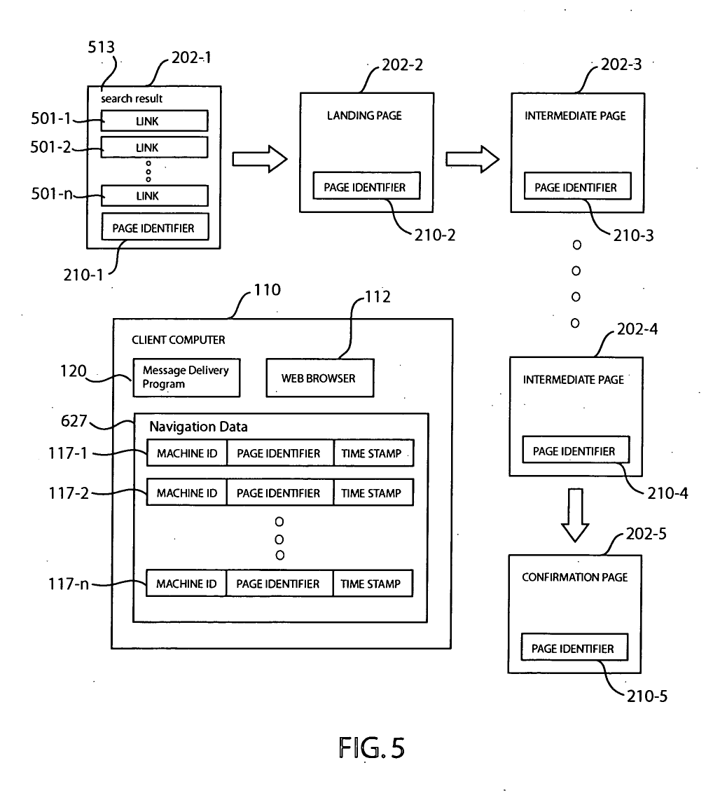

FIG. 5 pictorially illustrates a sequence of events that may occur when the consumer clicks on a link listed in a search result, in accordance with an embodiment of the present invention. In the example of FIG. 5, web pages 202 (i.e., 202-1, 202-2, . . . ) may be sequentially displayed in the same or separate windows of web browser 112. Each web page 202 includes a page identifier 210 (i.e., 210-1, 210-2, . . . ), which may be a URL. Message delivery program 120 records the URLs of web pages 202 viewed by the consumer as well the amount of time the consumer spent with each web page as navigation data. In the example of FIG. 5, navigation data 627 comprises log entries 117 (i.e., 117-1, 117-2, . . . ). Each log entry 117 includes a machine ID anonymously identifying the client computer 110 (or the consumer), a page identifier, and a time stamp indicating when the log entry 117 was made. The time stamps between log entries 117 provide an estimate of the amount of time the consumer spent viewing the indicated web page. A log entry 117 may be created for each web page 202 viewed by the consumer. For example, a log entry 117-1 may be created when the consumer clicks on a link 501 to receive web page 202-2 in client computer 110, a log entry 117-2 may be created when the consumer receives web page 202-3 in client computer 110, and so on.

In the example of FIG. 5, web page 202-2 is also referred to as a “landing page” because it is the web page directly pointed to by the corresponding link. A website that sells products online may also have a “confirmation page” 202-5. A confirmation page is a web page provided to the consumer to confirm a just completed online purchase. A website may have “intermediate pages” 202-3, 202-4, and so on between a landing page 202-2 and a confirmation page 202-5. An intermediate page may be an online product catalog, shopping cart, and other types of web pages. The page identifiers of landing and confirmation pages of popular or partner websites may be stored in database 171 of message server computer 140. The page identifiers of the landing and confirmation pages may be compared to those in navigation data 627 of a particular client computer 110 (identified by machine ID) to determine if the consumer operating the client computer 110 converted the activation of a search result link into a purchase. Techniques for monitoring consumer purchase behavior are also disclosed in U.S. application Ser. No. 10/464,419, entitled “Generation of Statistical Information In a Computer Network,” filed by David L. Goulden and Dominic Bennett on Jun. 17, 2003, which is incorporated herein by reference in its entirety.

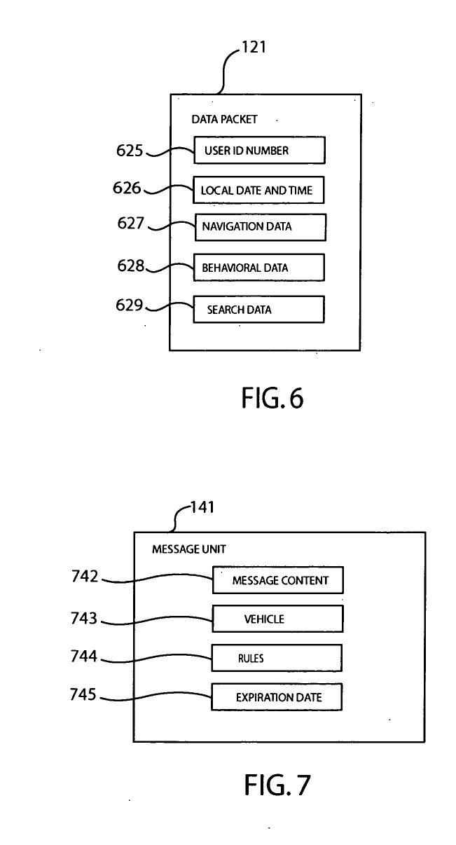

FIG. 6 schematically shows a data packet 121 in accordance with an embodiment of the present invention. A data packet 121 may include a user ID number 625 anonymously identifying the consumer or her client computer, local date and time 626 indicating when the data packet 121 was sent from the client computer 110 to message server computer 140, navigation data 627, behavioral data 628, and search data 629. Navigation data 627 include navigation related information, such as the websites visited by the consumer, web pages viewed, and so on. Example navigation data 627 has been discussed in connection with FIG. 5. Behavioral data 628 may contain information indicative of consumer online behavior, such as purchasing behavior, advertisements and links the consumer clicked on, and the like. Search data 629 include search related data, such as the search engines (e.g., as identified by URL) and keywords employed to perform a search, the contents of search results, the links and types of links on the search results, and the like.

Referring to FIG. 7, there is schematically shown a message unit 141 in accordance with an embodiment of the present invention. A message unit 141 may include a message content 742, a vehicle 743, rules 744, and an expiration date 745. Message content 742 may include computer-readable program code, text, images, audio, video, hyperlink, and other information. A message content 742 may be an advertisement or computer-readable program code for receiving an advertisement from an ad server, for example.

Vehicle 743 indicates the presentation vehicle to be used in presenting the message content indicated by message content 742. For example, vehicle 743 may call for the use of a pop-up, banner, message box, text box, slider, separate window, window embedded in a web page, or other presentation vehicle to display a message content. In the example of FIG. 2, advertisement 116 and presentation vehicle 115 may be specified in a message content 742 and vehicle 743, respectively, of a message unit 141.

Rules 744 indicate one or more triggering conditions for processing a message unit 141. Rules 744 may specify to display a message content 742 when a consumer navigates to a specific web page or as soon as the message unit 141 is received in a client computer 110. For example, a car company may contract with the operator of a message server computer 140 to deliver a message unit 141 containing an advertisement for a minivan (hereinafter, “minivan message unit”). The rules 744 of the minivan message unit may specify that the minivan advertisement is to be displayed to consumers viewing the minivan web page of “cars.com”. In this example, the minivan web page of cars.com has the URL “www.cars.com/minivans”. When a consumer visits the main page (or any web page) of “cars.com”, message delivery program 120 (see FIG. 2) will send a data packet 121 to message server computer 140 indicating that the consumer is on “cars.com”. In response, message server computer 140 will send the minivan message unit to client computer 110. When the consumer navigates to the URL “www.cars.com/minivans”, message delivery program 120 will detect that the minivan message unit has been triggered for processing (i.e., rules 744 of the minivan message unit have been satisfied). Accordingly, message delivery program 120 will process the minivan message unit by displaying it.

Rules 744 may also include: (a) a list of domain names at which the content of a message unit 141 is to be displayed, (b) URL sub-strings that will trigger displaying of the content of the message unit 141, and (b) time and date information. As shown in FIG. 7, a message unit 141 may also include an expiration date 745. Expiration date 745 indicates the latest date and time the message unit 141 can still be processed. In one embodiment, expired message units 141 are not processed even if their rules 744 have been satisfied. Expired message units 141 may be removed from client computer 110.

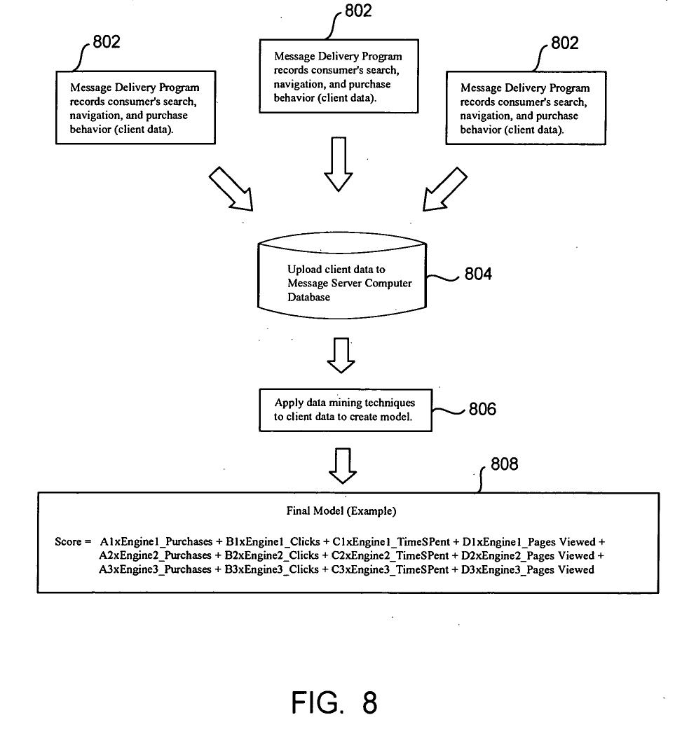

FIG. 8 pictorially illustrates the creation of a search model in accordance with an embodiment of the present invention. The search model may be employed in determining the relevance of a link to a keyword. The search model may assign a score to each link responsive to a keyword; the scores may then be compared to determine the most relevant links.

As previously discussed, message delivery programs running in client computers may be employed to record consumer search, navigation, and purchase behavior, which are collectively referred to as “client data” (box 802). Client data from the message delivery programs may be received in a message server computer for storage in a database (box 804). The client data contain information indicative of consumer preferred links for particular keywords. That is, the client data may be “mined” to determine the most relevant links for a keyword being searched. Furthermore, because the client data are collected by message delivery programs running in client computers (i.e., client side programs), the client data advantageously reflect the relevance of links as they appeared in several, different search engines.

Data mining techniques, such as linear regression or neural nets, for example, may be employed to create a search model for determining the relevance of a link to a keyword (box 806). An example search model is shown in box 808 of FIG. 8. In the example shown, a keyword-link combination is given a score according to several factors including: (a) the number of purchases made by consumers activating the link from a search result responsive to the keyword; (b) the number of clicks on the link; (c) the time spent by consumers viewing the web page pointed to by the link; and (d) the number of web pages connected to the link viewed by consumers. Additional factors may be taken into account depending on implementation. Each factor may be weighted to reflect its importance in determining the relevance of a link to a keyword. For example, algorithmic links may be given a higher weight than sponsored links. The search model may provide a score that reflects the relevance of the link as it appeared on different search results from different search engines.

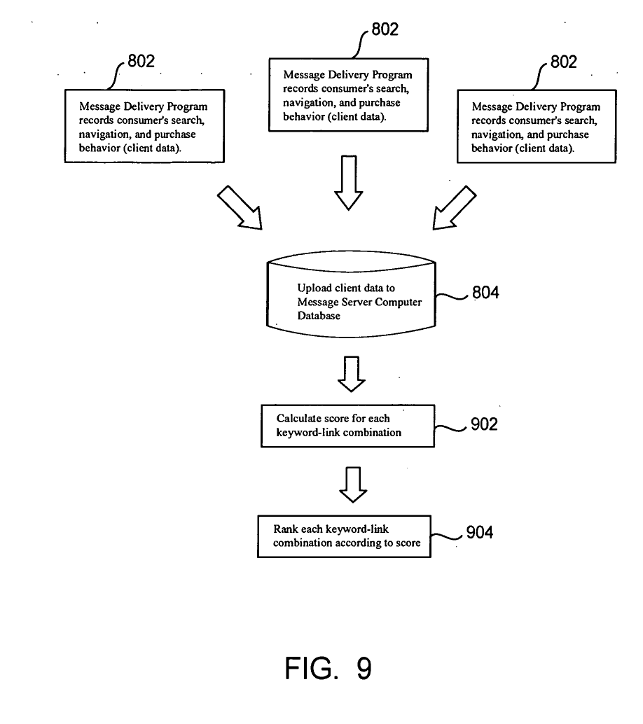

FIG. 9 pictorially illustrates a process for ranking links for particular keywords, in accordance with an embodiment of the present invention. As previously discussed in connection with FIG. 8, message delivery programs in client computers upload client data to the message server computer (boxes 802 and 804). Each link associated with a keyword (i.e., keyword-link combination) is scored using a search model (box 902). Each link associated with a keyword is then ranked according to its score (box 904). For example, links with higher scores may be ranked higher than those with lower scores; higher ranked links may be included in search results ahead of lower ranked links. The ranking may be stored in the message server computer database. This advantageously allows the message server computer to query its database to determine the most relevant links for a particular keyword.

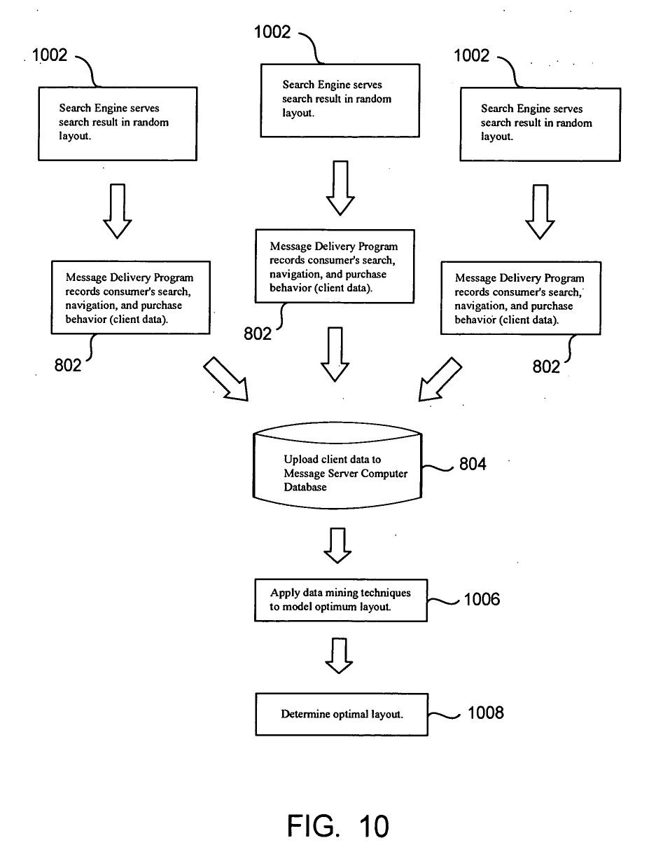

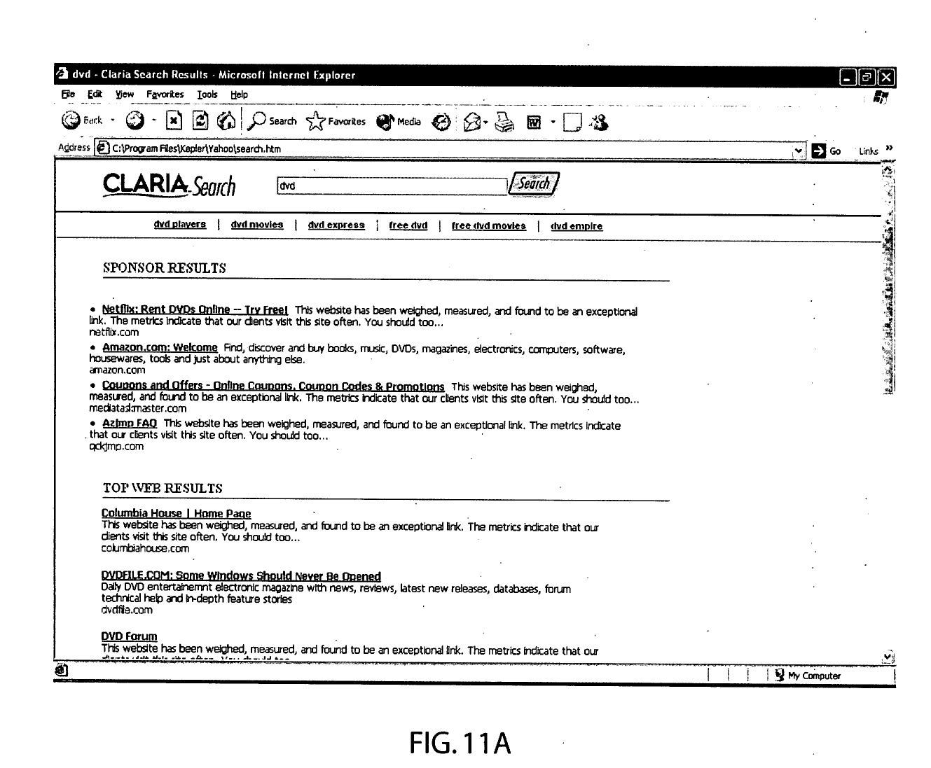

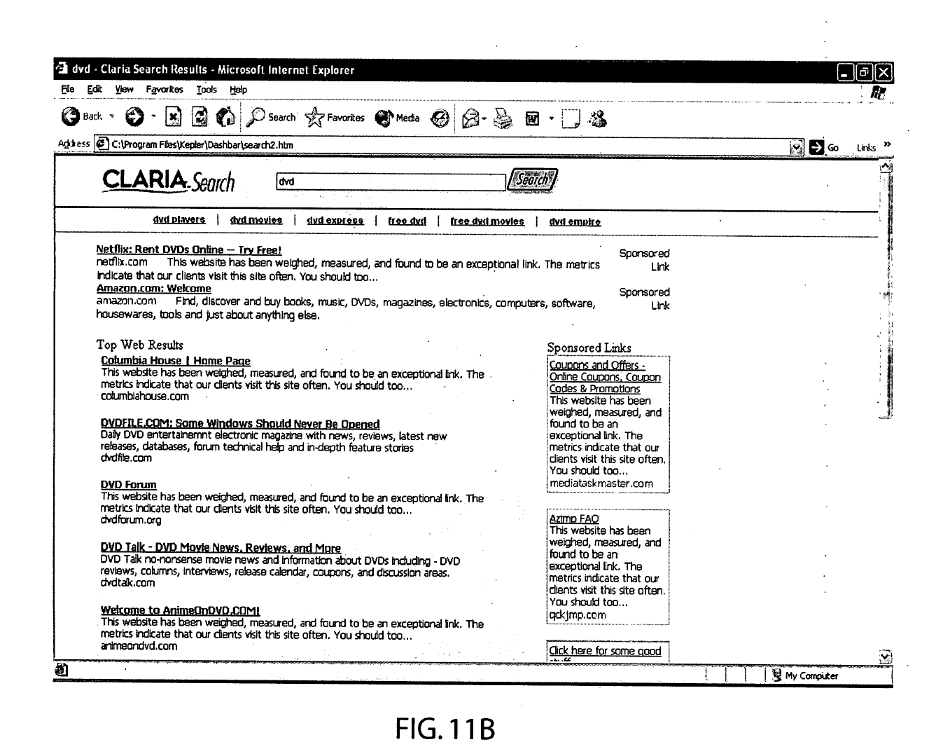

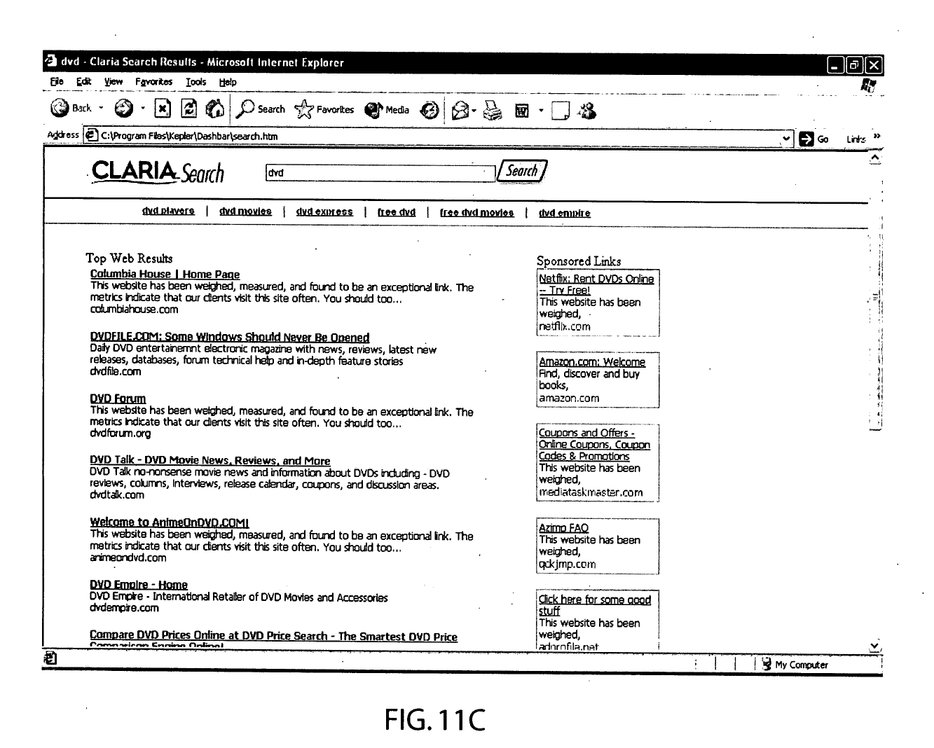

FIG. 10 pictorially illustrates a process for optimizing a layout for presenting a search result in accordance with an embodiment of the present invention. A search engine may present a search result in a variety of layouts. An example presentation layout is that shown in FIG. 4. Example presentation layouts in accordance with embodiments of the present invention include those shown in FIGS. 11A, 11B, and 11C. In the example of FIG. 11A, sponsored links are presented on top of other types of links. In the example of FIG. 11B, sponsored links are presented on top and on the right side of other types of links. In the example of FIG. 11C, sponsored links are presented on the side of other types of links. Other presentation layouts may also be used without detracting from the merits of the present invention. In one embodiment, each presentation layout may have a corresponding layout identifier. The layout identifier may be a non-visible portion of a web page that includes the search result. For example, a layout identifier may be a unique tag or comment on a web page's HTML code.

Referring to box 1002 of FIG. 10, a search engine may serve a search result to a client computer along with a layout identifier. This allows a message delivery program in the client computer to identify and record the layout identifier, if available, as search data in a data packet. Preferably, layouts for presenting search results are initially selected at random to allow for determination of which layout is most preferred by consumers. A message delivery program may record the layout identifier and consumer reaction to the layout (e.g., whether a consumer clicked on a link on the layout, whether a consumer made a purchase, . . . ) as part of search data provided to the message server computer (box 802). At the message server computer, client data (which include search data) are stored in a database (box 804). Data mining techniques, such as linear regression or neural nets, for example, may be applied to the stored client data to model an optimum presentation layout (box 1006). The layout model may take into account the number of consumers who clicked on a link as presented in one layout versus in another layout, as well as consumer navigation data, for example. The layout model may then be used to select the best layout for presenting a search result (1008).

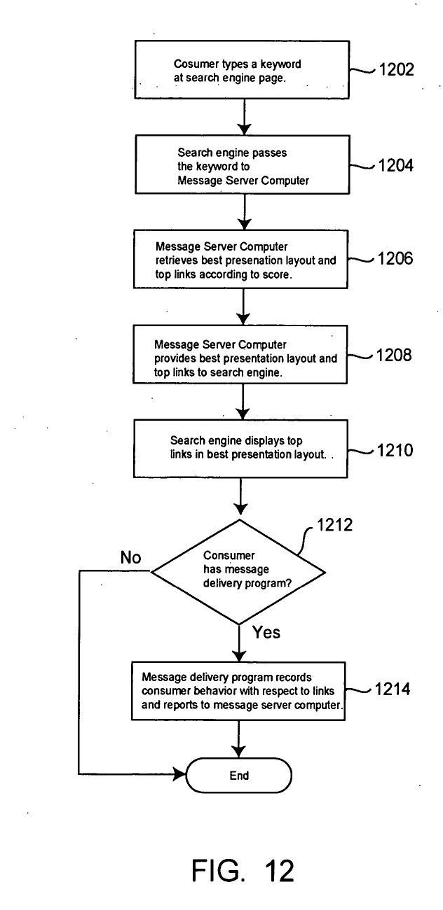

FIG. 12 shows a flow diagram of a method of responding to a search request in accordance with an embodiment of the present invention. The method of FIG. 12 may be implemented using the components and processes disclosed in FIGS. 1-10. Other components and processes may also be employed without detracting from the merits of the present invention.

In step 1202, a consumer performs a search by typing a keyword on a web page (e.g., web page 313 shown in FIG. 3) of a search engine (e.g., search engine 301-1 shown in FIG. 2). The search engine may be running on a web server computer (e.g., web server computer 160-1) on the Internet. In step 1204, the search engine passes the keyword to a message server computer (e.g., a message server computer 140). The message server computer may receive the keyword from the search engine over the Internet. For example, the search engine may send the message server computer a packet containing the keyword. In step 1206, the message server computer may query its database (e.g., database 171) or calculate for the highest ranked links responsive to the keyword, and for the best layout in presenting a search result. The links may be ranked according to scores assigned using a search model (e.g., see box 808 of FIG. 8). In step 1208, the message server computer provides the search engine the highest ranked links responsive to the keyword and the best presentation layout. The highest ranked links may be in the form of URLs, and sent to the search engine in the payload of a packet, for example. The best presentation layout may be in the form of a layout identifier; the search engine may be provided the corresponding format information for each layout identifier in advance. In action 1210, the search engine creates a search result that includes the highest ranked links, and formats the search result in accordance with the best presentation layout. The search engine then provides the search result to the consumer.

As can be appreciated, the links from the message server computer comprise highly relevant links in that they are determined based on client data obtained across several, different search engines. That is, the links from the message server computer are those known to be favored by consumers for particular keywords based on observations of consumer actions on more than one search engine. This allows a search engine to provide highly relevant search results to consumers.

Although the links are based on client data obtained from message delivery programs running in client computers, any client computer that can access the search engine may take advantage of embodiments of the present invention. For example, a consumer whose client computer does not have a message delivery program may still use the search engine to perform a search and receive a search result containing highly relevant links from the message server computer. If the consumer's client computer has a message delivery program, the message delivery program may record the consumer's navigation, search, and behavior for reporting to the message server computer, as indicated in actions 1212 and 1214.

While specific embodiments of the present invention have been provided, it is to be understood that these embodiments are for illustration purposes and not limiting. Many additional embodiments will be apparent to persons of ordinary skill in the art reading this disclosure.

1. A method of responding to a search request in a computer network, the method comprising:
receiving client data from a plurality of client computers, the client data being indicative of consumer preferred links for keywords employed to perform searches across different search engines on the Internet;
receiving a keyword from a search engine; and
providing the search engine a plurality of links pointing to at least one document on the Internet, at least one link in the plurality of links determined to be relevant to the keyword based on the client data.

2. The method of claim 1 further comprising creating a search model using the client data, the search model being configured to provide a score indicative of a relevance of a link to the keyword.

3. The method of claim 1 wherein the client data are stored in a database in a message server computer in communication with a message delivery program generating client data.

4. The method of claim 1 further comprising:
informing the search engine of a best layout in presenting the plurality of links.

5. The method of claim 1 wherein links associated with the keyword are assigned corresponding scores using a search model.

6. The method of claim 1 further comprising:
including the plurality of links in a search result provided to a first client computer of a consumer.

7. The method of claim 6 wherein a link in the plurality of links point to a web page.

8. The method of claim 6 wherein the first client computer does not have a client program in communication with a server computer providing the plurality of links to the search engine.

9. The method of claim 1 wherein the client data comprise consumer navigation history.

10. The method of claim 1 wherein the client data comprise consumer purchase behavior.

11. The method of claim 1 wherein the at least one link is determined to be relevant to the keyword based on a number of times consumers clicked on the at least one link.

12. The method of claim 1 wherein the at least one link is determined to be relevant to the keyword based on a number of times consumers made a purchase by following the at least one link.

13. The method of claim 1 wherein the at least one link is determined to be relevant to the keyword based on an amount of time consumers spent viewing a web page pointed to by the at least one link.

14. A system for providing search results, the system comprising:
a plurality of client computers, each of the client computers including a message delivery program that is configured to record client data indicative of consumer preferred links for keywords employed to perform searches across different search engines; and
a message server computer configured to receive client data from the message delivery program in each of the client computers, the message server computer storing a ranking of links associated with particular keywords, the ranking being based on client data.

15. The system of claim 14 further comprising:
a search engine configured to receive a search request for a keyword from a first client computer, the search engine being configured to provide the keyword to the message server computer and to receive a set of links from the message server computer, the links in the set of links determined to be relevant to the keyword based on the client data.

16. The system of claim 14 wherein the search engine is configured to receive information on a best layout to be used in presenting the set of links from the message server computer.

17. The system of claim 14 wherein the links in the set of links point to web pages on the Internet.

18. The system of claim 14 further comprising:
a search model created using the client data and configured to provide a score for a link, the score being indicative of relevance of the link to a keyword.

19. A method of responding to a search request, the method comprising:
receiving a search request for a keyword from a client computer; and
providing a search result responsive to the search request, the search result including at least one link that is determined to be relevant to the keyword based on consumer actions with respect to the link as displayed on different search results from different search engines.

20. The method of claim 19 wherein the link is determined to be relevant based on client data received from a plurality of client programs provided to consumers in exchange for a product provided free of charge or at a reduced cost.
